(19) United States
(12) Patent Application Publication
(10) Pub. No.: US 2003/0236707 A1
(43) Pub. Date: Dec. 25, 2003

(54) Configuring a product with user settings during a network purchase

(76) Inventor: Douglas A. Cheney, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/174,757

(22) Filed: Jun. 19, 2002

(51) Int. Cl. G06F 17/60

(52) U.S. Cl. 705/26

(57) ABSTRACT

A network store for selling products to purchasers interacting with the network store through an electrical communication link is disclosed herein. The network store comprises a product configuration program that allows a purchaser to select user settings for a product purchased through the network store. The network store further comprises a link to a configuration installer that configures the product according to the selected user settings.

### TECHNICAL FIELD OF THE INVENTION

The present invention is generally related to a network store. More particularly, the present invention is related to systems and methods for providing a network store that allows a purchaser to select user settings of a product during a purchasing process.

### BACKGROUND OF THE INVENTION

In the past several years, network stores have been developed to allow purchasers to buy products and services using a computer connected to the Internet. FIGS. 1-3 illustrate a conventional scheme in the prior art for on-line shopping. FIG. 1 is an example of a prior art on-line store 10 that includes web page programs having screen displays that aid in the shopping experience. The on-line store 10 typically comprises a “welcome” program 12 that displays a welcome screen to introduce the buyer to the on-line store 10. The on-line store 10 further comprises a commerce application 14 that includes several programs that display product information, product selection steps, and purchasing instructions. After a purchase, a “thank you” program 16 displays a screen that thanks the buyer for making a purchase and exits the buyer out of the purchasing procedure.

The commerce application 14 may comprise configurator 18, cart 20 and check-out 22 programs. A database 24 may receive along bus 26 the purchaser's selections during use of the configurator program 18. The database 24 places the selections in the cart program 20, which stores the selections. When the purchaser has finished shopping, the on-line store 10 executes the check-out program 22 so that the purchaser may pay for the products held in the cart program 20. The check-out program 22 completes the purchasing transaction.

The configurator 18 configures the web pages to display requested product information and has access to registers that store the product information. The configurator program 18 may have access to registers such as pricing registers 28, product views registers 30, lead times registers 32, validation registers 34, and merchandising registers 36. The configurator 18 may further direct the purchaser through the product selection options through selection screens based on input from the purchaser.

In FIGS. 2A and 2B, the prior art on-line store 10 is accessed via the Internet 38 using a computer system 40 comprising, for example, a monitor 42, a central processing unit (CPU) 44, a keyboard 46, and a mouse 48. The purchaser inputs product selection data into the computer system 40 using the keyboard 46 or mouse 48. The computer system 40 sends the selections via the Internet 38 to the on-line store 10. In response to requests from the purchaser, the on-line store 10 provides information such as product pricing and views back to the purchaser along the Internet 38. Once the purchase has been completed, the on-line store 10 informs a product shipping department to ship the product and any applicable invoices to a mailing address requested by the purchaser. A distributor 50 may be electrically connected to the on-line store 10 for receiving shipping instructions.

The prior art purchasing process only allows a buyer to select available products and the options that the products may comprise. Therefore, the purchaser normally may only choose products and options, but nothing more. The prior art purchasing process is silent concerning issues of product setup, since products are typically shipped in the condition they were manufactured, according to pre-configured manufacturer's defaults.

Although the prior art on-line shopping experience may be relatively easy, improvements are still needed in the purchasing process in order to make the entire process of purchasing and setting up the product smoother and more efficient. For example, when a product is selected during the prior art purchasing process, the products are typically shipped with standard manufacturer's defaults. When the buyer receives the shipped product, particularly electrical equipment, the buyer may be required to establish several setup parameters before the product can be used. At this point, it may be necessary for the purchaser to read complex and confusing setup instructions. If the purchaser is unable to understand the setup instructions, the purchaser may have to contact the seller, either by phone or by Internet, to consult experts with questions about proper setup. Since several days may pass from the time of purchase to the time of product arrival, a purchaser can become anxious to use the product and can easily overlook important setup instructions. Thus, a need exists in the industry to address the aforementioned deficiencies and inadequacies to improve the on-line purchasing process.

### SUMMARY OF THE INVENTION

According to one embodiment of the present disclosure, a network store is disclosed for selling products to a purchaser interacting with the network store using an electrical communication line. The network store comprises a product configuration program that allows the purchaser to select user settings for the product purchased through the network store. The network store further comprises a link to a configuration installer that configures the product according to the selected user settings.

The present disclosure further comprises methods for selling products, wherein one method comprises receiving a request from a purchaser to select one of a number of products that are available for sale. In response, the seller presents a plurality of user settings options to the purchaser and receives the purchaser's selected user settings options. Before the product is shipped, the selected product is configured with the selected user settings.

A computer data signal embodied in a carrier wave transmitted between a buyer and a seller is also disclosed herein. The computer data signal comprises a seller component that comprises product information data. The computer data signal further comprises a buyer component that comprises product selection data and product configuration selection data that instructs the seller to configure the selected product based on selected user settings.

The present disclosure further comprises a computer-readable medium that comprises logic configured to receive a product order from a customer. The computer-readable medium further comprises logic configured to present the customer with a plurality of user settings options for the ordered product and logic configured to receive a customer's selection of the user settings options. In addition, the computer-readable medium comprises logic configured to instruct a configuration installer to configure the ordered product according to the received user settings options selection.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Like reference numerals designate corresponding parts throughout the several views.

FIG. 1 is a block diagram of the prior art network store.

FIGS. 2A and 2B are partial block diagrams illustrating the interactions between a purchaser and the prior art network store of FIG. 1.

FIG. 3 is a partial block diagram illustrating an embodiment of an interaction between a purchaser and a network store according to the present invention.

FIGS. 4A through 4D are sample views of screen displays shown to the purchaser during an example embodiment of a network store purchase using the network store shown in FIG. 3.

FIGS. 5A and 5B illustrate two example sheets of a user settings menu map showing user settings of a sample product.

FIG. 6 is a block diagram of a generalized schematic of an example product purchased according to the methods of the present invention.

FIG. 7 is a flow chart of an embodiment of a network store purchasing method.

### DETAILED DESCRIPTION OF THE INVENTION

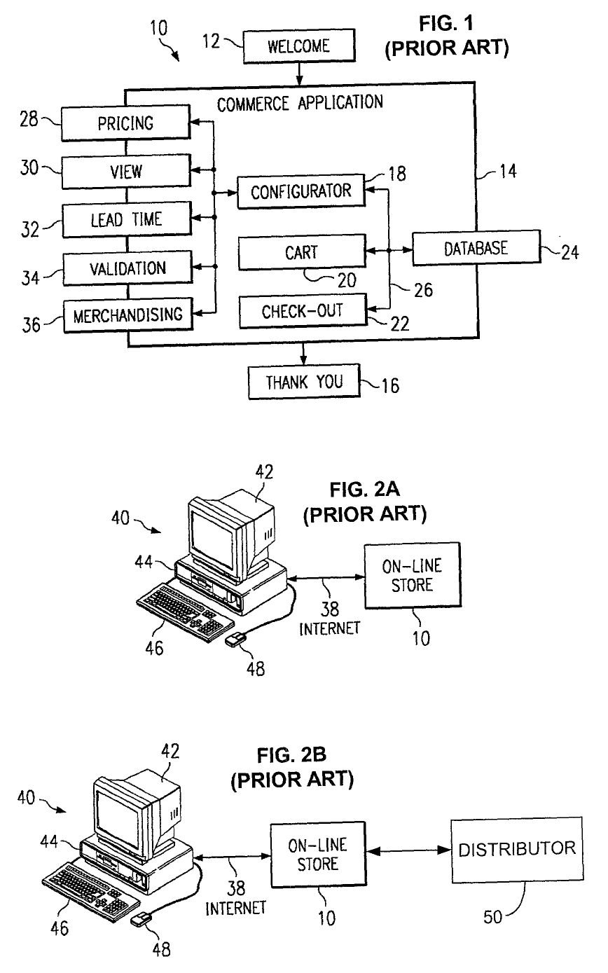

In the prior art example of FIGS. 1, 2A, and 2B, when a purchaser orders a product, particularly an electronic product having multiple user settings, the purchaser may be required to go through a sequence of setup steps to configure the product to the user's needs. For example, a printing device typically has several user settings that must be entered into the product before it is used. In the example wherein the product is a printing device, setup may require the user to enter user settings such as paper handling features, print quality features, power saving features, etc. In the examples disclosed herein, a printing device may refer to an electronic device having the capability to produce a hardcopy image on a paper-based medium. The term “printing device” used herein may refer to a printer, copier, facsimile machine, multi-function printing machine, all-in-one printing device, etc. Although the examples disclosed herein refer to a printing device, it is to be understood that the purchased product may be any product having configurable user settings.

The prior art allows a purchaser to merely purchase a product, but does not further allow a purchaser to select user settings during the purchasing process. The present disclosure improves the buying process by allowing the purchaser to select the user settings at the time of purchase. While the purchaser goes through the product selection process, the network store described herein may prompt the purchaser to input the particular needs of the people who will use the product. Therefore, the user settings may be selected and established in a network environment wherein electronically-based descriptions and definitions of products and user settings may be presented during the buying process.

When the user settings are established at the time of purchase, the network store may make a record of the purchaser's choices so that the same choices may be used as a default for future purchases by the same purchaser. The purchaser's record may be conveniently stored for easy access during subsequent orders. Another benefit of establishing the user settings at the time of the network purchase is that the product, e.g. the printing device, may be set up by a trained installer who is knowledgeable of the proper steps in setting up the product. When a trained expert configures the product, there is no need for the purchaser to go through the confusing configuration process. It is more likely that the product configuration will be conducted properly by an expert, and there would be no need for telephone calls to the manufacturer's support staff to guide the user through the difficult process. This method further eliminates the need for a hardcopy manual instructing a person unskilled in configuring printers or other products how to perform a task that the person will probably never perform again.

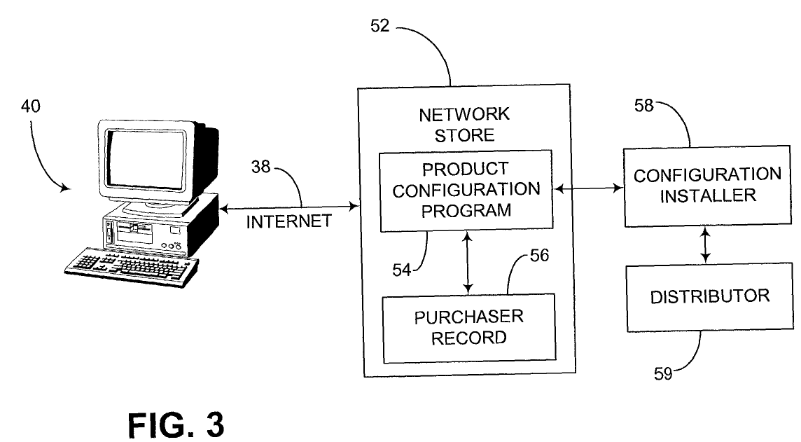

FIG. 3 illustrates a schematic diagram of an embodiment for conducting a sales transaction between a purchaser and a seller. The purchaser may use a computer system 40 to access the Internet 38 so as to open a sales transaction channel between the computer system 40 and a network store 52. The sales transaction channel may comprise an on-line Internet connection or alternatively may comprise a local store kiosk, electronic catalogue terminal, etc. A computer data signal, which may be embodied in a carrier wave, is transmitted between a buyer interface, e.g. the computer system 40, and a seller interface. The computer data signal comprises a seller component that is transmitted from the seller interface to the buyer interface. The seller component or segment may comprise information about the available products for sale as well as add-on options and selectable user settings. A buyer component or segment may comprise product selection data, option selection data, and/or product configuration selection data, which instructs the seller in the manner that the seller is to configure the selected product. Alternatively, the sales transaction channel may include a wireless network wherein communication between the purchaser and seller may be performed by wireless communication techniques.

The network store 52 may comprise welcome and thank you programs as well as product selection commerce applications to allow the purchaser to select products from available products for sale. The network store 52 may further comprise a product configuration program 54 that allows the purchaser to make more detailed selections than are normally available. Not only does the network store 52 allow the selection of products and the available options on the selected products, but also the product configuration program 54 of the network store 52 further allows the selection of configuration parameters or user settings. The network store 52 presents the selectable user settings to the purchaser and may present the user settings in a web page showing the various options available for the particular user settings.

When the purchaser chooses the user settings, the product configuration program 54 establishes a record that may be stored in memory, such as a purchaser record 56. In future purchases, the purchaser may access the purchaser record 56 to retrieve the user settings that were selected in a previous purchase. Additionally, the product configuration program 54 notifies a configuration installer 58 of the product and product's user settings selected by the purchaser. The configuration installer 58 may be a person who is skilled at configuring the particular products or may be a computer or robotic controlled apparatus for automatically configuring the product. The installer 58 receives the user setting signals and configures the product according to the purchaser's selections.

When the product is properly configured, the product is transferred to a distributor 59 that packages the product and ships the product to the purchaser. The network store 52, configuration installer 58, and distributor 59 are shown in FIG. 3 as separate entities. However, two or more of these entities may be combined as one unit or department, depending on the available equipment and the needs and desires of the selling or distributing companies involved.

The purchasing system shown in FIG. 3 may provide one of a plurality of benefits over other prior art systems, wherein, when the purchaser is considering the particular needs of a person using the prospective product, the purchaser can select the product and option, and, in addition, select the particular user settings to tailor the product to the needs. Therefore, the product can be purchased and configured in one network session, without the need to further configure the product once it arrives at the purchaser's mailing address. A benefit of the FIG. 3 system over in-person purchases is the advantage of allowing a configuration installer 58 to manipulate configuration controls to properly set up the product to the desired user settings before the product is packed for shipping. In in-person sales transactions, a salesperson typically does not open the packaging and configure the product for the customer. Furthermore, it is unlikely that a salesperson will be sufficiently familiar with the product to help in the configuration process. Therefore, when a purchaser buys a product in person, the purchaser is stuck with the manufacturer's defaults and must configure the product using complex setup instructions.

The network purchasing program, including the product configuration program 54 of the network store 52, comprises an ordered listing of executable instructions for implementing logical functions and can be embodied in any computer-readable medium for use by an instruction execution system, apparatus, or device, such as a computer-based system, processor-controlled system, or other system that can fetch the instructions from the instruction execution system, apparatus, or device and execute the instructions. In the context of this document, a “computer-readable medium” can be any medium that can contain, store, communicate, propagate, or transport the program for use by the instruction execution system, apparatus, or device. The computer-readable medium can be, for example, an electronic, magnetic, optical, electromagnetic, infrared, or semiconductor system, apparatus, device, or propagation medium. More specific examples of the computer-readable medium include the following: an electrical connection having one or more wires, a portable magnetic computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, for instance, by optical scanning of the paper or other medium, then compiled, interpreted or otherwise processed in a suitable manner if necessary, and then stored in a computer memory. In addition, the scope of the present invention includes embodying the functionality of the embodiments of the present disclosure in logic embodied in hardware or software-configured mediums.

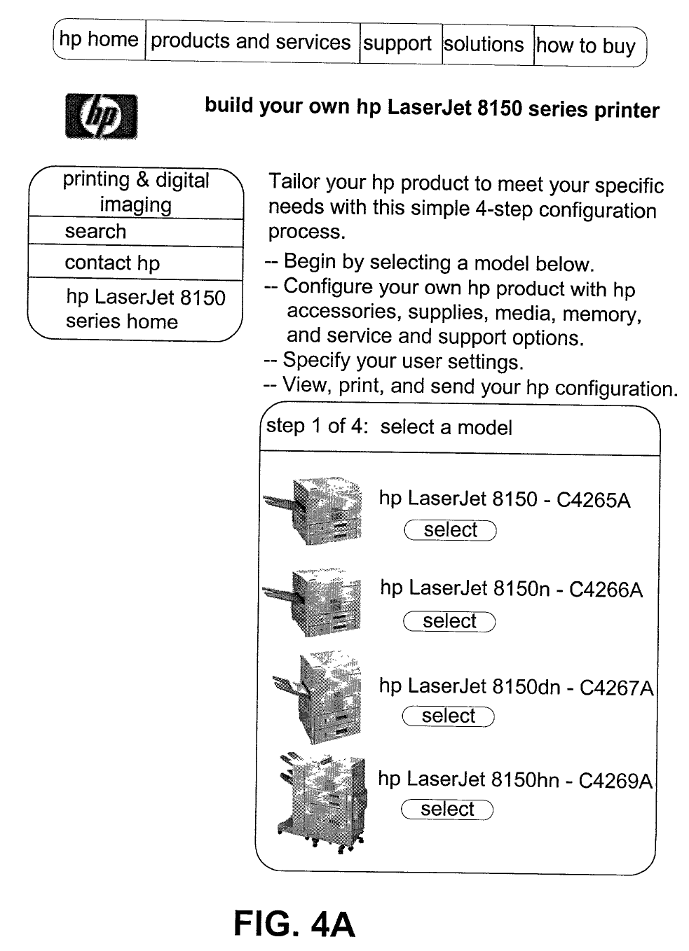

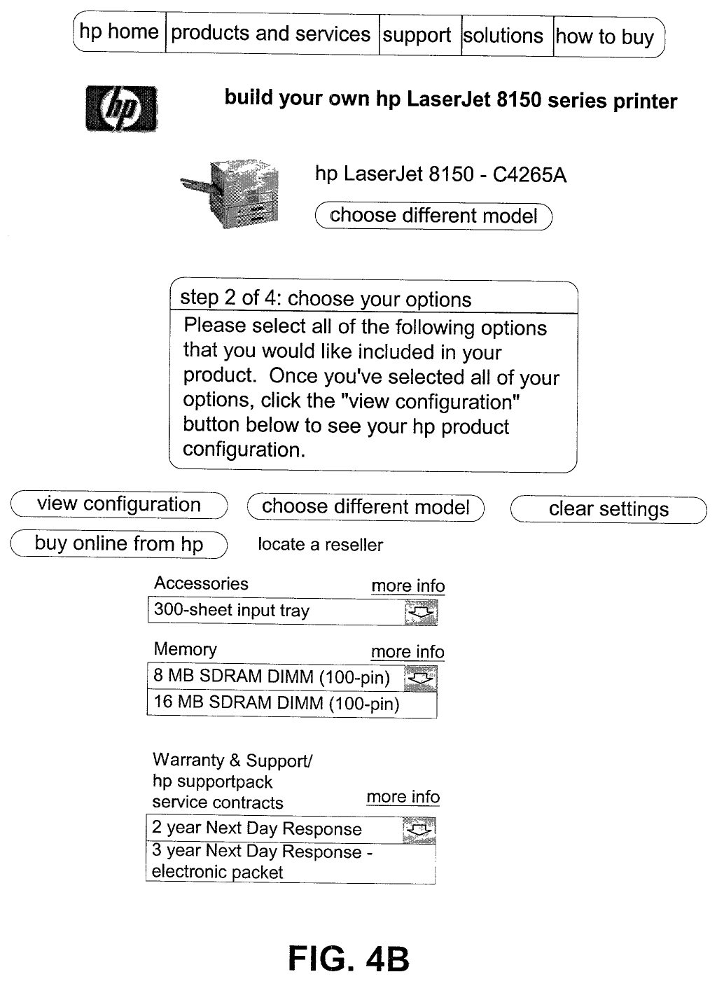

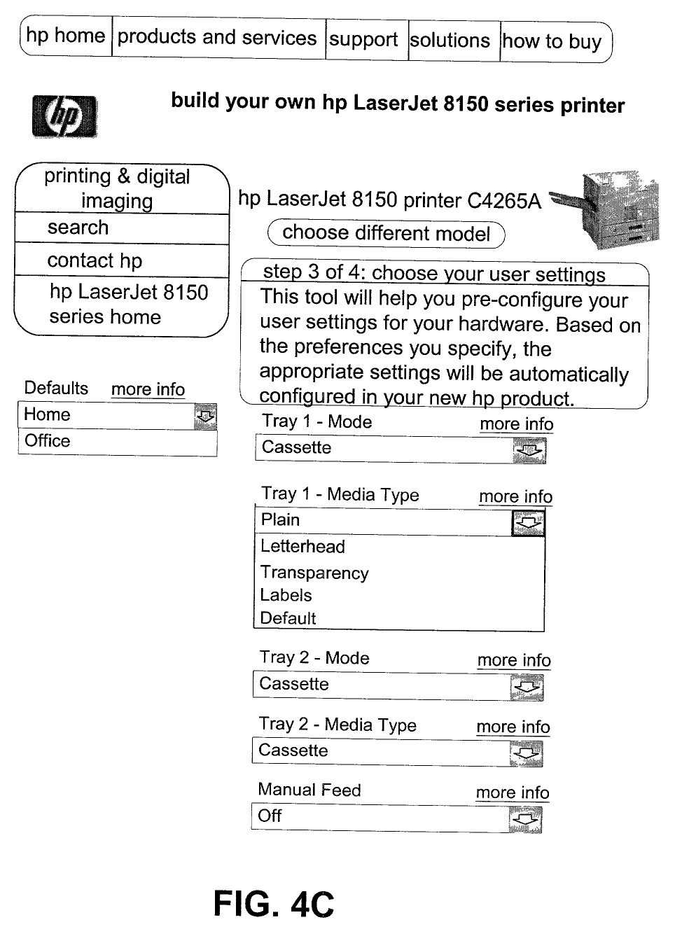

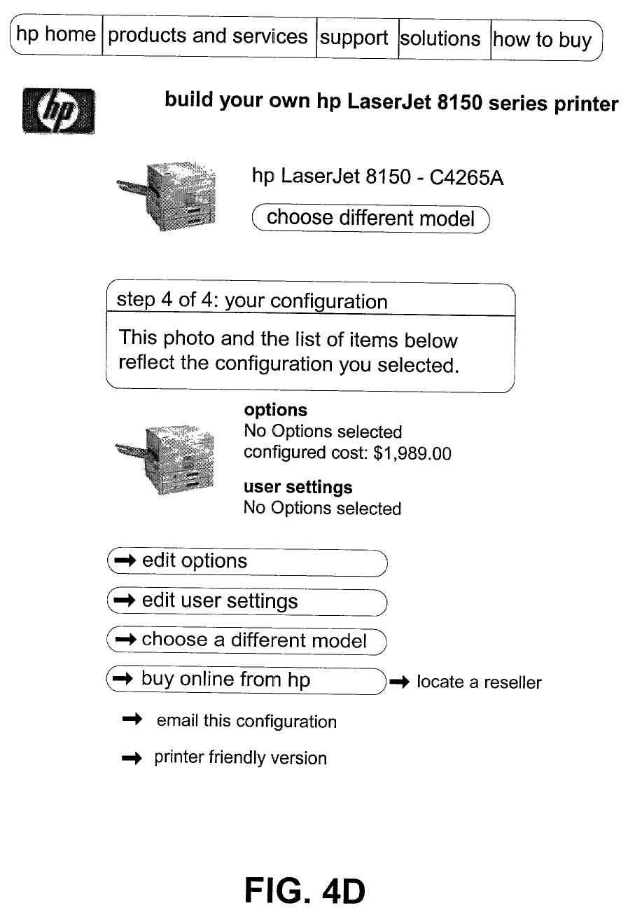

FIGS. 4A-4D illustrate example embodiments of screen views of network (e.g., web) pages of the network store 52 that may be used to lead a purchaser through a network shopping process. In this example embodiment, the screen views show a purchasing process for purchasing an HP LaserJet printer. However, other examples of different companies and products may be viable. Therefore, the present disclosure applies to any product purchased in a network or on-line environment, wherein a user inputs user settings of the product during a network purchasing process. Since printing devices normally require the input of many user settings before use, this printer example is indicative of the capabilities of the network store 52 described herein.

FIG. 4A is a network screen display showing a first step of four steps in the network purchasing process. This process may be expanded or edited to include greater or fewer steps. The first step prompts the purchaser to select a model from a group of products. Again, products other than printing devices may be included. Furthermore, any number of products may be made available for selection. The screen display may instruct the purchaser of the overall buying process and may provide other options allowing the purchaser to inquire about further information about each product. Once the purchaser has selected a product in step one, a new screen may be displayed showing the next step in the purchasing process.

FIG. 4B is a view of the screen display showing a second step of the four steps. In step two, the purchaser is prompted to choose the options on the selected product. The options include the add-on items, peripherals, or additions that supplement the selected product, depending on the needs of the purchaser. In the example wherein the product is a printer, the selectable options may include accessories such as paper trays, synchronous dynamic random access memory (SDRAM) having different storage capacities, and even warranty and service contracts. Once the options are selected, the network store proceeds to the next step.

In FIG. 4C, a third step of choosing the user settings or configuration parameters is presented on the screen. At this stage of purchase, the purchaser utilizes the product configuration program 54 of the network store 52. The purchaser is given the chance to configure the product to meet desired specifications or needs. By making selections in this step, the purchaser ultimately instructs the trained configuration installer 58 how to configure the product. Therefore, before the network store 52 or distributor 59 ships the product to the user, the configuration installer 58 configures the product, allowing the users to use the product upon arrival without going through the complex product configuration steps that are required in the prior art when the product arrives with the manufacturer's default configurations.

This third step may utilize the product configuration program 54 to ask for the selection of various aspects, options, and features of the product configuration. The purchaser may enter information concerning product configurations, such as, in the printing device example, tray mode configurations, paper or media type, printing quality, printing resolution, manual feeding information, economy modes, fonts, power saving features, toner warnings, etc. At this stage, the purchaser may receive an explanation of each of the different user settings by clicking on a link to a specific user setting definition. When the user settings have been entered, the network store 52 leads the purchaser to the last of the four steps.

FIG. 4D is a screen view of a fourth step in the purchasing process. This view may recapitulate the selected product, product add-on options, and user settings. The screen may further show a breakdown of the costs of the product and the additional costs of the add-on options. An additional cost may be included for the service of configuring the product to meet the selected user settings, depending on the complexity of the configuration process. The screen may include further opportunities to edit previously selected choices or to continue with the purchase. At this time, the purchaser may buy the product or edit the choices.

The network store 52 of the present disclosure can be implemented in hardware, software, firmware, or a combination thereof. In the disclosed embodiments, the network store 52 is implemented in software or firmware that is stored in a memory and that is executed by a suitable instruction execution system. If implemented in hardware, as in an alternative embodiment, the network store 52 can be implemented with any or a combination of the following technologies, which are all well known in the art: a discrete logic circuit having logic gates for implementing logic functions upon data signals, an application specific integrated circuit (ASIC) having appropriate combinational logic gates, a programmable gate array (PGA), a field programmable gate array (FPGA), etc.

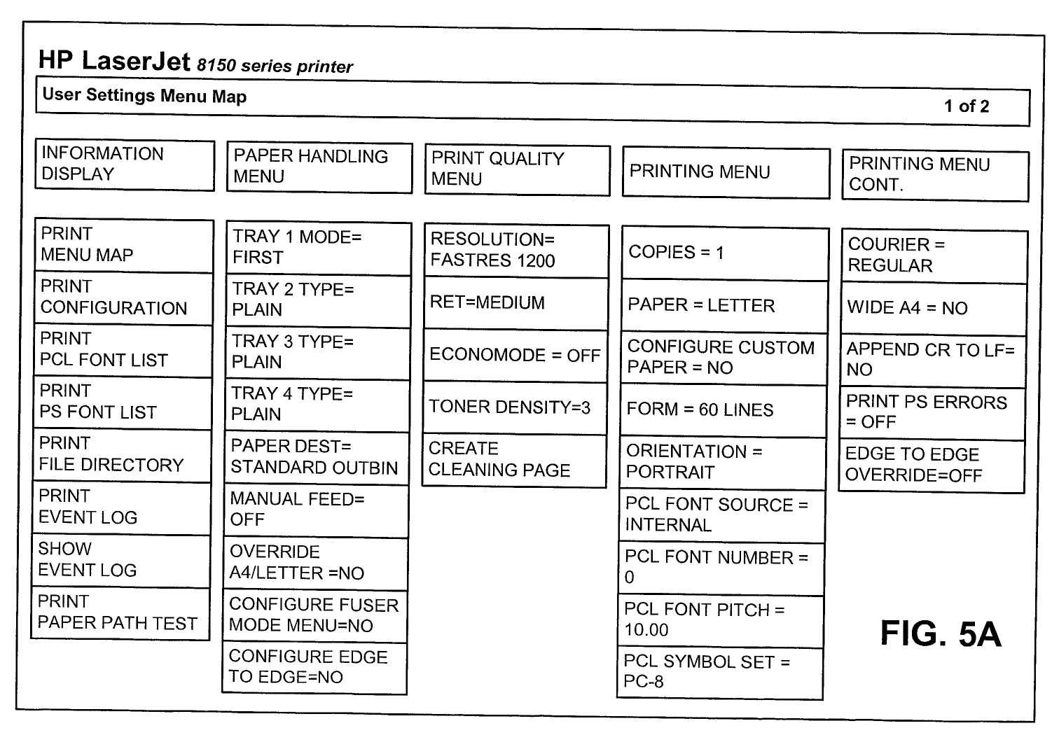

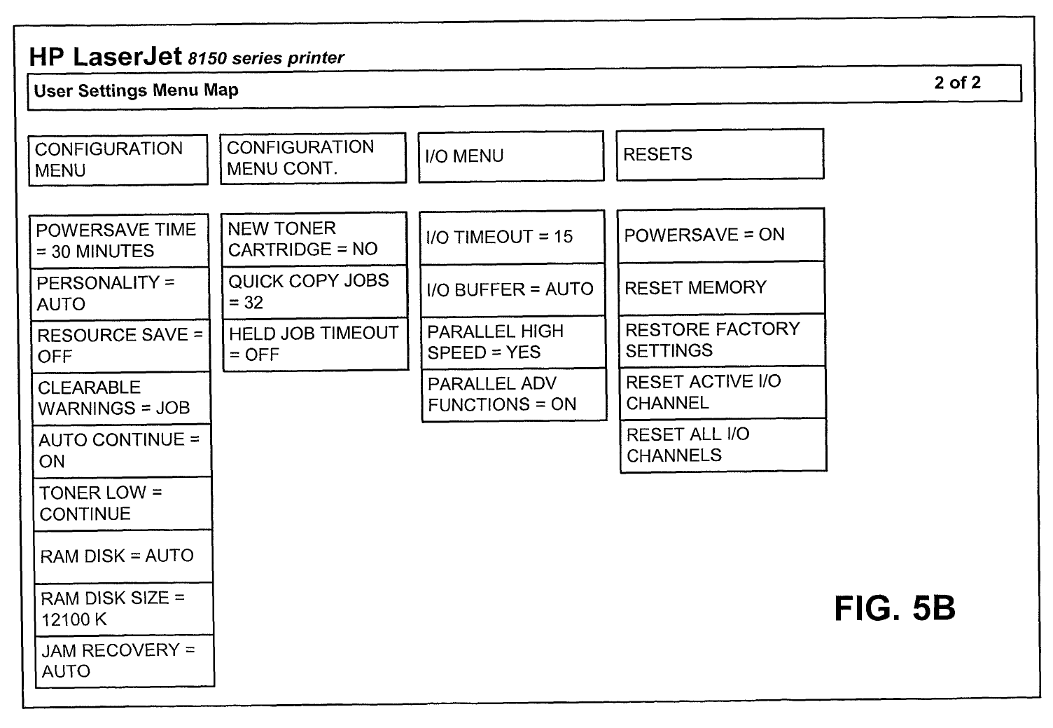

FIGS. 5A and 5B show two example sheets of information describing the particular user settings of an example printer. The information sheets may be printed as a user settings menu map that displays the available user settings for a printer, e.g. an HP LaserJet 8150 series printer. The user may print the user settings menu map using the printer product to obtain a hardcopy record showing the choices made during the network purchasing process. If changes to the user settings are made after the installation of the product, the user settings menu map will reflect these changes.

The information on the user settings menu map established at the time of purchase is provided to the configuration installer 58 so that the product can be properly configured before being shipped by the distributor 59. The configuration installer 58, knowledgeable of the purchased product, may take the selected information and easily make modifications to the product settings to configure the product to the purchaser's desires. The configuration installer 58 is trained with respect to the products available for sale and will be instructed how to configure the products according to the user settings. The configuration installer 58 may configure the product by switching external or internal switches on the product, and by operating a product management tool, such as a hardware configuration circuit or a software tool. Other means for configuring the product may be used, such as adjusting dials, pressing buttons, or inputting values or parameters using one or more input interface, such as, for example, a keyboard, keypad, mouse, dial, switch, etc.

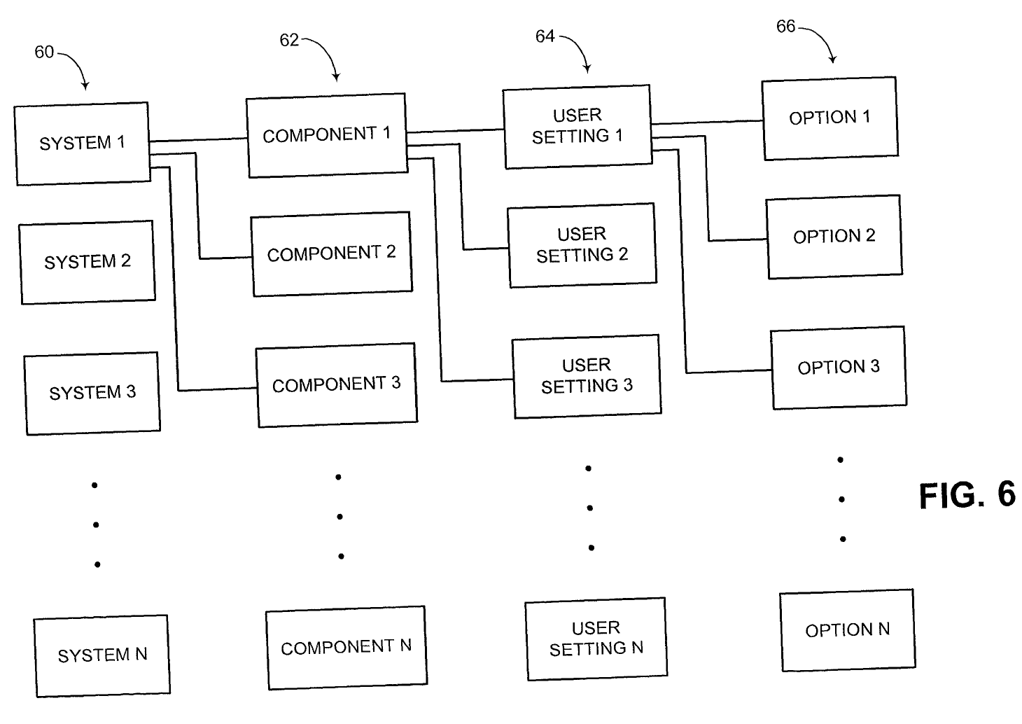

FIG. 6 is a block diagram of a generalized scheme wherein a purchaser may select options of user settings from multiple options for a particular product. The purchaser selects a product or system 60 from a number of selectable choices. The selected product 60 may comprise a number of components 62, wherein each component 62 may be an inherent component of the product 60 or an accessory that can be added to the system 60. In the example wherein the system 60 is a printer, the components 62 may be physical components, such as paper trays, keypads, etc. or even service components, such as warranties, service contracts, etc. In an alternative embodiment wherein the system 60 is a computer, for instance, the computer product may comprise different components 62. Each component 62 may have variable characteristics that may be adjusted or changed in order to calibrate or configure the component to meet particular needs of the purchaser. These characteristics may be user settings 64 or other configuration parameters to tailor the component 62 to a user's desires. The user settings 64 are broken down into a number of options 66, wherein each option is a value or setting within a range of options 66 that are available for selection.

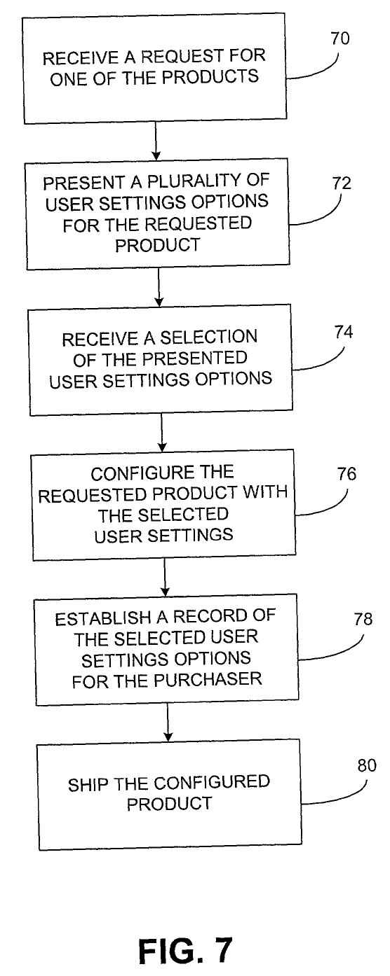

FIG. 7 is a flow chart for performing steps involved in an embodiment for operating the network store 52 wherein at least one product for sale includes user settings. In accordance with the present disclosure, the configuration installer 58 configures the product according to the selected user settings. Block 70 shows a first step wherein the network store 52 receives a request from a purchaser wishing to purchase a product from a number of available products for sale.

In block 72, the network store 52 communicates back to the purchaser, presenting the purchaser with a plurality of options of various user settings that are available with the selected product. The purchaser makes selections from the available options and sends an indication of the selections back to the network store 52. In block 74, the network store 52 receives the selection of the user settings options. Once the user settings options are received, the network store 52 informs an installer 58 or distributor 59 of the user's selections. The installer 58 builds the product with the selected accessories and further configures the product with the selected user settings, as indicated in block 76. The installer 58 may configure the product by switching internal or external switches, running installation software, adjusting variable potentiometers, inputting user parameters, and/or other means for entering, adjusting, or inputting values, parameters, settings, or characteristics to tailor the product to specific configurations, modes, or states desired by the users. For example, when the product is a printer, the installer 58 may enter user settings such as tray mode, paper type, manual feeding modes, economy modes, fonts, power saving features, toner warning features, etc. Furthermore, the installer 58 may establish one or more of the user settings as a default. Thus, the product may power up in the default mode according to the selected user settings options and the user may select alternative options if desired.

Once the product has been properly built and configured according to the purchaser's wishes, the network store 52 establishes a purchaser record 56 of the user settings that were selected by the purchaser, as indicated in the step shown in block 78. The purchaser record 56 can be made available to the same purchaser or to a group of related purchasers within a family or business department or group. With access to the purchaser record 56, the purchasers may utilize the record 56 during future purchases. When the product is properly pre-configured, the distributor 59 ships the configured product to an address provided by the purchaser, as indicated in block 80.

The flow chart of FIG. 7 shows the architecture, functionality, and operation of a possible implementation of the network purchasing process, which can be implemented in software. In this regard, each block represents a module, segment, or portion of code, which comprises one or more executable instructions for implementing the specified logical function(s). It should also be noted that in some alternative implementations, the functions noted in the blocks may occur out of the order noted in FIG. 7. For example, two blocks, e.g. blocks 76 and 78, shown in succession in FIG. 7 may in fact be executed substantially concurrently or the blocks may sometimes be executed in the reverse order, depending upon the functionality involved, as will be further clarified hereinbelow.

It should be emphasized that the above-described embodiments of the present invention are merely examples of possible implementations, set forth for a clear understanding of the principles of the invention. Many variations and modifications may be made to the above-described embodiments of the invention without departing from the principles of the invention. All such modifications and variations are intended to be included herein within the scope of this disclosure and protected by the following claims.

I claim:

1. A network store for selling a product to a purchaser interacting with the network store via an electrical communication link, the network store comprising:
a product configuration program adapted to allow the purchaser to select user settings for the product purchased through the network store; and
a link connecting the product configuration program to a configuration installer, adapted to configure the product according to the user settings selected by the purchaser.

2. The network store recited in claim 1, wherein the product includes a printing device.

3. The network store recited in claim 2, wherein the user settings include at least one paper handling setting.

4. The network store recited in claim 2, wherein the user settings include at least one print quality setting.

5. The network store recited in claim 2, wherein the user settings include at least one printer setting.

6. The network store recited in claim 2, wherein the user settings include at least one input/output setting.

7. The network store recited in claim 2, wherein the user settings include at least one configuration setting.

8. The network store recited in claim 2, wherein the user settings include a plurality of paper handling settings, a plurality of printer quality settings, a plurality of printing settings, a plurality of input/output settings, and a plurality of configuration settings.

9. A method for selling a product with pre-configured user settings, the method comprising the steps of:
receiving a request from a purchaser to select one of a number of available products;
presenting a plurality of user settings options of the selected product;
receiving a selection of the presented user settings options;
configuring the selected product with the selected user settings; and
shipping the configured product to the purchaser.

10. The method recited in claim 9, further comprising the step of establishing a record of the selected user settings.

11. The method recited in claim 10, wherein the step of establishing a record comprises establishing a record that is accessible to the purchaser.

12. The method recited in claim 9, wherein the step of receiving a request to select one of a number of available products comprises receiving a request to select a printer model from a number of available printers.

13. The method recited in claim 12, wherein the step of presenting a plurality of user settings options comprises presenting user settings selected from the group consisting of paper handling options, print quality options, print setting options, input/output settings options, and configuration options for the requested printer.

14. The method recited in claim 9, further comprising a step of receiving payment for the configured product.

15. A user interface for a network store, comprising:
means for presenting a number of electronic devices to a customer;
means for allowing the customer to select one of the electronic devices for purchase; and
means for allowing the customer to choose user settings for the selected electronic device.

16. The user interface recited in claim 15, wherein the means for allowing the customer to choose user settings further comprises means for presenting the customer with a plurality of user settings options from which to choose.

17. The user interface recited in claim 16, wherein the plurality of user settings options includes at least one default option.

18. The user interface recited in claim 16, wherein the electronic device includes a printer and the user settings options are selected from the group consisting of paper handling options, print quality options, print setting options, input/output settings options, and configuration options for the printer.

19. A computer data signal embodied in a carrier wave transmitted between a buyer and a seller, comprising:
a seller segment comprising product information data; and
a buyer segment comprising product selection data and product configuration selection data that instructs the seller to configure a selected product for sale, based on selected user settings.

20. The computer data signal recited in claim 19, wherein the product for sale comprises a printing device and the user settings are selected from the group consisting of paper handling settings, print quality settings, input/output settings, and configuration settings for the printing device.

21. A computer-readable medium, comprising:
logic configured to receive a product order from a customer;
logic configured to present the customer with a plurality of user settings options for the ordered product;
logic configured to receive from the customer a selection of the presented user settings options; and
logic configured to instruct a configuration installer to configure the ordered product according to the selected user settings options.

22. The computer-readable medium recited in claim 21, wherein the user settings options include at least one default setting.

23. The computer-readable medium recited in claim 22, wherein the product is a printing device and the user settings options are selected from the group consisting of paper handling options, print quality options, print setting options, input/output settings options, and configuration options for the requested printer.

24. A method of conducting an electronic sales transaction, the method comprising the steps of:
receiving a signal indicative of a selected product for purchase;
receiving a signal indicative of selected option of the selected product;
receiving a signal indicative of user settings of the selected product and options;
configuring the selected product with the selected user settings;
establishing a record of the selected user settings; and
distributing the configured product to a product user.

25. The method recited in claim 24, wherein the electronic sales transaction is conducted on-line.

26. The method recited in claim 25, wherein the on-line transaction comprises the communication of a buyer and a seller over the Internet.

27. The method recited in claim 24, wherein the electronic sales transaction is conducted using a wireless network.
